(19) United States
(12) Patent Application Publication
(10) Pub. No.: US 2007/0041363 A1
(43) Pub. Date: Feb. 22, 2007

(54) Search and navigation method within voice over internet protocol (VOIP) advertisements player

(76) Inventor: Peter J. Ferras, (US)

Correspondence Address: STETINA BRUNDA GARRED & BRUCKER, 75 ENTERPRISE, SUITE 250, ALISO VIEJO, CA, 92656, US

(21) Appl. No.: 11/207,537

(22) Filed: Aug. 19, 2005

(51) Int. Cl. H04L 12/66

(52) U.S. Cl. 370/352; 370/401

(57) ABSTRACT

Provided is a telecommunications system for searching for at least one informational message on a data processing system. The telecommunications system comprises a computer readable storage medium, a display device, and a VOIP dialer having a dialog box. The computer readable storage medium operates on the data processing system. The display device is in communication with the data processing system. The VOIP dialer having the dialog box is displayable on the display device and is operative to receive a user request in the dialog box, retrieve the informational message from the computer readable source medium, and display the informational message on the dialog box conterminously with the user's search request.

### CROSS-REFERENCE TO RELATED APPLICATIONS

Not Applicable.

### STATEMENT RE: FEDERALLY SPONSORED RESEARCH/DEVELOPMENT

Not Applicable.

### BACKGROUND OF THE INVENTION

The present invention relates generally to telecommunications systems and, more particularly, to a uniquely configured telecommunications system that is specifically adapted to allow a user to retrieve and display at least one informational message such as a commercial advertisement from among a plurality thereof which may be stored on a data processing system. The telecommunications system is further adapted to receive user input that may be responsive to the informational message and which may further facilitate voice communications between a user and a host device using Voice over Internet Protocol (VOIP).

VOIP is a relatively new telecommunications technology that allows for voice communications over the internet. More specifically, VOIP allows for the user of a personal computer (PC) in combination with existing internet infrastructure over which data may be sent and received in an efficient manner via packet switching. Packet switching allows for the retrieval and sending of data through a network of routers on the internet. Packet switching allows for data packets to be handed off from router to router.

Importantly, each data packet includes an internet protocol (IP) address indicating where the data is to be ultimately received regardless of the non-linear manner in which the data packet is transmitted over the maze of internet connections. In this manner, packet switching in VOIP provides a means by which voice communications occupy only a fraction of the space in the internet network compared to that which is occupied by a dedicated conventional telephone network.

As is well known, certain types of telephone services such as long distance telephone service are relatively costly for the average consumer. Consumers are regularly courted by long-distance telephone services providers with offers of cheaper long distance phone charges. As is well known, intense competition exists amongst conventional telephone service providers for new subscribers. Although VOIP service providers can offer lower rates due to the efficiency of VOIP systems, consumers have yet to subscribe in large numbers to VOIP service providers as a means for reducing their telephone bills.

Because of the increased cost of long distance telephone service, there exists a need in the art for a telecommunications system by which consumers may reduce their telephone costs. More specifically, there exists a need in the art for a system and method by which the average consumer as well as business owners can capitalize on the efficiency and high quality provided by VOIP telephone systems.

Furthermore, there exists a need in the art for a telecommunications system that is less expensive than traditional telephone networks that are burdened with substantial infrastructure costs due to heavy regulation and taxation. Finally, there exists a need in the art for a telecommunications system that allows business owners to instantly provide custom tailored advertisements to consumers based on the particular user's search and identifier preferences.

### BRIEF SUMMARY OF THE INVENTION

The present invention overcomes the above-referenced need for a telecommunications system. More particularly, the present invention provides a telecommunications system that is specifically adapted for searching for an informational message on a data processing system and displaying the informational message on a display device. Such display device may be included with a personal computer (PC) or other electronic device. The display device may be configured as a monitor screen wherein a VOIP dialer having a dialog box may be displayed on the display device to enable a user to input a response to the informational message and thereby connect the VOIP dialer to a host device for communication therebetween.

The telecommunications system comprises a computer readable storage medium of the data processing system, a display device that is in communication with the data processing system, and the VOIP dialer having the dialog box. The VOIP dialer is operative to receive a search request that may be inputted by the user into the dialog box on the search field thereof. The VOIP dialer retrieves the informational message from the computer readable storage medium of the data processing system and displays the informational message conterminously (i.e., simultaneously) with the user search request status. In this manner, the user can observe the status of any inputs on the search request as the search request is being processed by the computer readable storage medium.

The telecommunications system of the present invention further provides a means by which a sponsor of the informational messages may subsidize the utilization of VOIP telephony of a user in placing and receiving VOIP phone calls from a personal computer (PC) via the keypad of the VOIP dialer. In this regard, the sponsor of the informational messages subsidizes VOIP services and may then be charged for telephone calls made by the user using the VOIP system in return for the ability of the sponsor to display commercial advertisements for goods and services on the user's PC.

The informational messages may optionally include non-commercial messages such as community service messages, system information messages such as status on the data processing system, humorous messages, graphic images such as photographic works, logos, slogans, and can additionally include text, graphics, sound, animations, video and other forms of media and various combinations thereof. The VOIP dialer and/or the telecommunications system may display all informational messages in any of the above mentioned forms of in any combination thereof.

### BRIEF DESCRIPTION OF THE DRAWINGS

These as well as other features of the present invention will become more apparent upon reference to the drawings wherein:

FIG. 1 is an exemplary screen shot of a dialog box of a Voice over Internet Protocol (VOIP) dialer that may be displayed on a display device such as a personal computer;

FIG. 2 is an enlarged view of the dialog box of the VIOP dialer illustrating a keypad and an informational message displayed on the dialog box;

FIG. 3 is a flow chart illustrating the steps by which a user may retrieve an informational message from a computer readable storage medium of a data processing system using the VOIP dialer;

FIG. 4 is a flow chart illustrating a method by which a user may retrieve and display the informational message on the display device wherein the informational message is based upon a user's search request and at least one user identifier; and

FIG. 5 is a block diagram of the telecommunications system illustrating a display device in communication with a host device.

### DETAILED DESCRIPTION OF THE INVENTION

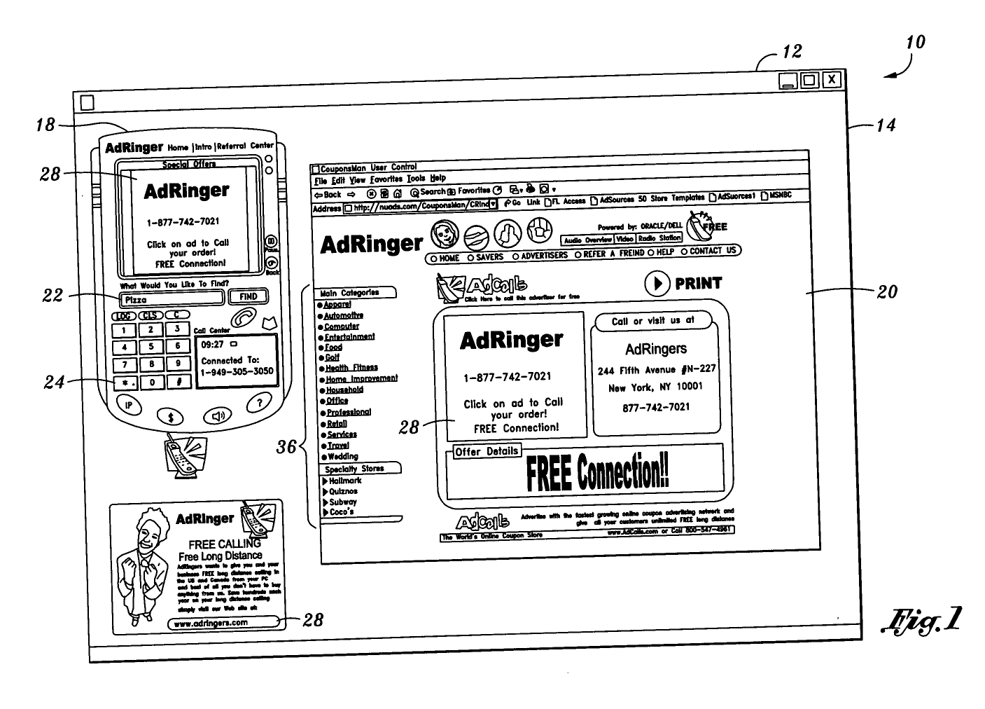

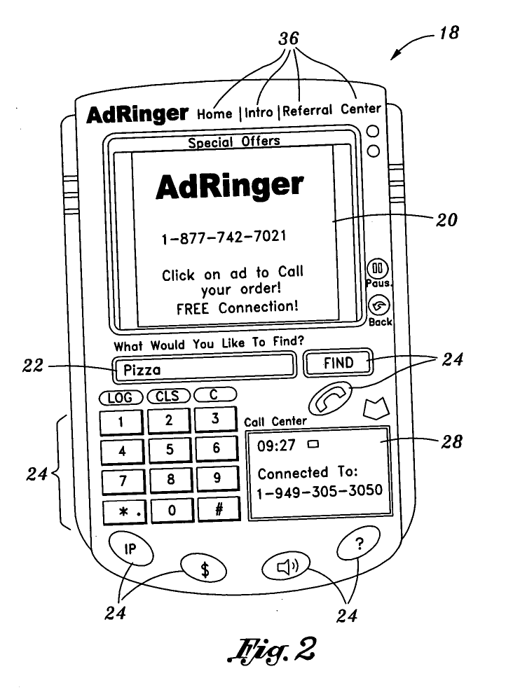

The present invention will now be described in particular with reference to the accompanying drawings. FIGS. 1 and 2 illustrate a screen shot of a display device 12 in a telecommunications system 10 which is specifically adapted for searching for at least one informational message 28 on a data processing system 26. Advantageously, the telecommunications system 10 of the present invention provides a system and method by which the informational message 28 can be displayed on the display device 12 such as a personal computer 16 (PC) monitor screen 14 and wherein a VOIP dialer 18 having a dialog box 20 displayed on the display device 12 enables a user to input a response to the informational message 28 as well as connect the VOIP dialer 18 to a host device 34 for communication therebetween.

In its broadest sense, the telecommunications system 10 comprises a computer readable storage medium 32 of the data processing system 26, a display device 12 that is in communication with the data processing system 26, and the VOIP dialer 18 that has the dialog box 20 which is displayable on the display device 12. Notably, the VOIP dialer 18 is operative to receive a user search request that may be inputted by the user into the dialog box 20. The VOIP dialer 18 is then operative to retrieve the informational message 28 from the computer readable storage medium 32 of the data processing system 26. Once retrieved, the VOIP dialer 18 is then operative to display the informational message 28 on the dialog box 20 conterminously (i.e., simultaneously) with the user search request status. In this regard, the telecommunications system 10 provides a means by which the user can observe the status of any inputs on the search request as the search request is being processed by the computer readable storage medium.

Advantageously, as was earlier mentioned, the telecommunications system 10 of the present invention further provides a means by which a sponsor of the informational messages 28 may subsidize the utilization of VOIP telephony in placing and receiving VOIP telephone calls from a personal computer 16 (PC) via a keypad 24 of the VOIP dialer 18. In this regard, the sponsor of the informational messages 28 subsidizes VOIP services and is then charged for telephone calls made by the user using the VOIP system in return for the ability of the sponsor to display the sponsor's informational messages 28 (e.g., commercial advertisements for goods and services) on the user's PC.

The informational messages 28 may further include community service messages, system information messages such as status on the data processing system 26, humorous messages, graphic images such as photographic works, logos, slogans, and can additionally include text, sound, animations, video and other forms of media and various combinations thereof. In this regard, the VOIP dialer 18 and/or the telecommunications system 10 is operative to display informational messages 28 in the above mentioned forms.

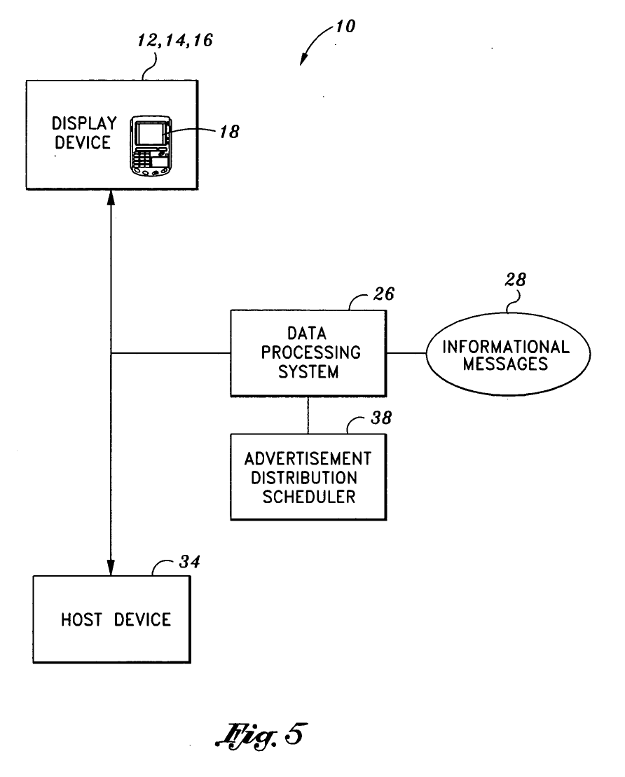

Referring briefly to FIG. 5, shown is a block diagram of the telecommunications system 10 of the present invention illustrating a display device 12 in communication with a host device 34. The data processing system 26 interposed between the display device 12 and the host device 34 enables communications therebetween and further provides a storage device for storing the informational messages 28 therewithin. As was earlier mentioned, sponsors such as business owners who wish to provide informational messages 28 in the form of commercial advertisements to users may gather user preference information through surveys completed and submitted by the user upon downloading software that enables use of the VOIP dialer 18.

As will be described in greater detail below, such sponsors and affiliates thereof may advantageously use the user information such as user search preferences and user search request data in order to optimize targeting and personalization of commercial advertisements for the user. In this manner, such sponsors may potentially increase revenues. In this manner, such sponsors may develop customer databases that may allow for the capture of additional revenues from users due to more focused marketing.

The telecommunications system 10 of the present invention may comprise an advertisement distribution scheduler 38 that is in communication with the data processing system 26. Preferably, the advertisement distribution scheduler 38 is operative to assign a demographic profile reach to each informational message 28 (e.g., advertisement) which may then allow for allocation of such informational messages 28 to a specific group or list of users. In this regard, the advertisement distribution scheduler 38 is operative to create an assignment of specific ones of the informational messages 28 to users.

As an example, and not for purposes of limiting the same, the informational message 28 of a particular sponsor may be framed as advertisement such as for a food item. The advertisement may be assigned by the advertisement distribution scheduler 38 to residents within a specific area code, zip code, state, country or any other geographic boundary parameter. Such advertisement may have associated with it an advertisement contract which may specify a demographic profile reach for the specific advertisement. In addition, the advertisement distribution scheduler 38 may be operative to store at least one of a frequency, duration, and expiration time of the advertisement.

In this regard, the frequency of the advertisement is defined as the frequency of which the advertisement is retrieved and displayed upon a particular user's display device 12. Duration of the advertisement may be defined as the duration of each occurrence of the advertisement on the user's display device 12. The above mentioned parameters such as frequency, duration and expiration of time of the advertisement as well as demographic profile reach may be parameters of the advertisement contract that may be stored in a database management system.

In exploiting such information, the advertisement distribution scheduler 38 may assign certain advertisements to be allocated or distributed to certain users. In a representative embodiment, a member or user profile may be stored in a database management system and may be utilized to transmit such parameters to the advertisement distribution scheduler 38. It is contemplated that other sources may be utilized to obtain information which may be utilized to develop the demographic profile reach as utilized by the telecommunications system 10. Ultimately, the demographic profile reach is stored in the database management system and is utilized to generate a list of users to which informational messages 28 such as advertisements may be allocated or distributed.

The advertisement distribution scheduler 38 may additionally include functionality to assist in maximizing advertisement revenues for sponsors of the informational messages 28. Furthermore, the advertisement distribution scheduler 38 may minimize certain system costs by reviewing and recording usage profiles of each particular user garnered from the user's statistical information. More specifically, statistical information may be collected from the user's log file of the user's personal computer 16. In this manner, the advertisement distribution scheduler 38 may be used to ascertain and develop the amount of consumption of informational messages 28 by a particular group of users over a predetermined period of time. Furthermore, the advertisement distribution scheduler 38 may monitor the extent and degree to which informational messages 28 such as advertisements are allocated or displayed for viewing by the user. In addition, time of expiration of the advertisements may be monitored such that advertisements of sponsors may be better allocated to users who are more likely to be exposed to advertisements prior to the expiration period thereof.

As was earlier mentioned, the telecommunications system 10 is specifically configured in one aspect to retrieve from the data processing system 26 certain informational messages 28 that are selected using predefined user search preferences. More specifically, such user search preferences may be utilized to target specific types of informational messages 28 to the user. For example, user search preferences may include at least one of the following: food types, automotive information, business names, career information, entertainment information, games such as electronic games, music information, news, sports information, hobby information, community service information, as well as data processing system 26 status information. As was earlier mentioned, the collection of such user search preferences allows for sponsors of the informational messages 28 to easily capture vital demographic data about such users to further focus and target the allocation of the informational messages 28.

Such informational messages 28 are preferably, but optionally, configured as advertisements for any number of goods and/or services although other informational messages 28 may be provided. As in the example cited above, a particular one of the informational messages 28 may be configured as an advertisement for a specific food type that may be assigned and allocated to a specific user or users that reside within a specific area code.

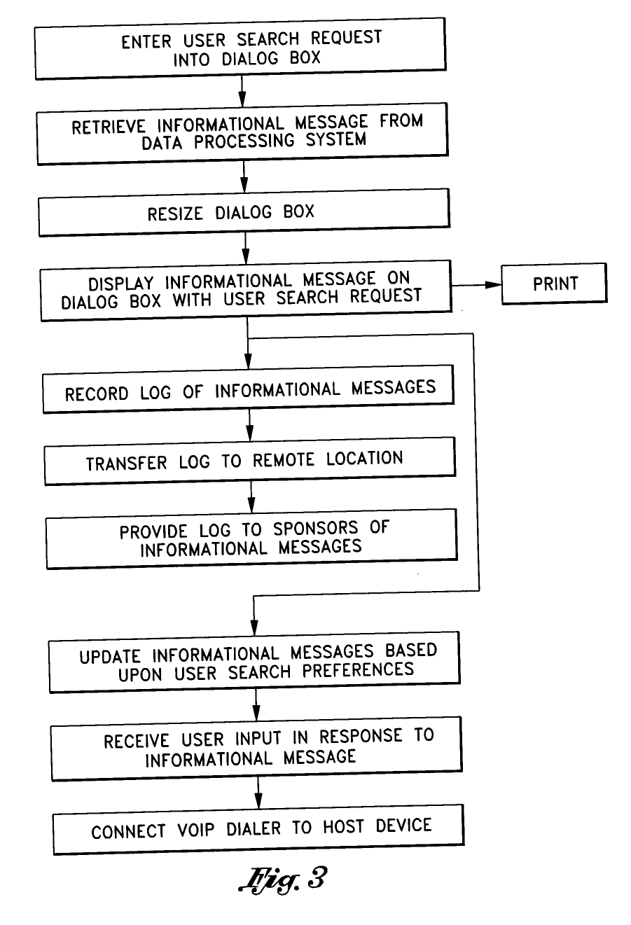

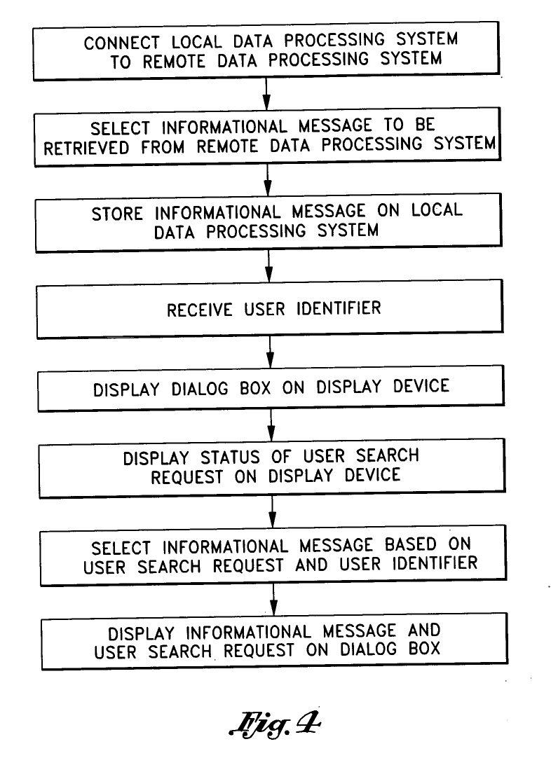

Referring now to FIGS. 3-4, also disclosed herein is a method for retrieving at least one informational message 28 from the computer readable storage medium of the data processing system 26. As was earlier mentioned, the method utilizes the telecommunications system 10 as described above which utilizes the VOIP dialer 18 and which is in communication with the data processing system 26. The method further allows for searching and navigating using the VOIP dialer 18 to ultimately display an informational message 28. The search and navigation functions allow for the retrieval of at least one informational message 28 from the computer readable storage medium.

Such informational message 28 may be selected based upon a geographical location or proximity to the data processing system 26. The method for retrieving the informational message 28 comprises the steps of entering the search request into the dialog box 20 and retrieving the informational message 28 from the data processing system 26 based upon predefined user search preferences. The informational message 28 may be based upon a geographical location of the data processing system 26. Upon retrieval of the information message, the dialog box 20 may optionally be resized on the display device 12 such that at least part of the user search request status may be visible by the user.

As can be seen in FIG. 1, the display device 12 may comprise a monitor screen 14 of a personal computer 16 but may optionally be configured in any medium. The method may further comprise the step of displaying the informational message 28 on the dialog box 20 conterminously with the display of the user search request status. Such resizing of the dialog box 20 may be automatically performed due to the configuration of the telecommunications system 10. Preferably, the dialog box 20 is automatically resized on the display device 12 such that at least part of the user search request status may be displayed and visible to the user.

The display of the dialog box 20 on the display device 12 provides a means to view the status of the user search request and also allows for navigation of specific informational messages 28 (i.e., advertisements) during various phases of the user search request. For example, the dialog box 20 may be displayed during initial activation of the user search request during idle mode of the user search request, as well as during dialing of the VOIP dialer 18 and processing of the user search request information inputted into the dialog box 20. It is contemplated that the informational message 28 may be displayed on a display device 12 conterminously with the display of the user search request and/or status of navigation of informational messages 28 by the user. Such display may continue at least until processing of the user search request and/or navigation by the user. Alternatively, such processing may continue until terminated by the user.

Upon receipt of the informational message 28, a user may wish to contact a sponsor of the informational message 28 wherein the user may initiate a voice conversation with the sponsor or an affiliate of the sponsor. During such time it is contemplated that the telecommunications system 10 is preferably configured to allow continuous input of user search request on the search field 22 of the VOIP dialer 18. The telecommunications system 10 may also allow for navigation of informational messages 28 during such VOIP session modes. It is further contemplated that the step of displaying the informational message 28 may be performed inside the dialog box 20 which may optionally be configured as a scrollable HTML-compatible window containing at least one hypertext link 36.

As is well known in the art, hypertext links 36 allow a user to access information of the linked source by simply clicking on the link such as with a mouse of a personal computer 16. As can be seen in FIG. 1, such hypertext links 36 are visible on the left hand side of the display device 12 and allow a user to connect to websites offering a variety of goods and services in various categories. It is further contemplated that a print function may be provided with the informational message 28 to allow printing thereof from a printing device. Such print function may enable printing of the informational message 28 displayed on the display device 12.

The method may further comprise the step of displaying the informational message 28 along with at least one of a current time of day and/or current date as may be stored within the data processing system 26. As can be seen, such time information may be provided with the VOIP dialer 18. Optionally, the step of displaying the informational message 28 may further include a flash interactive movie compatible window or other movie or video software programs. Further optionally, such informational message 28 with the interactive movie compatible window may include active hypertext links 36 to other informational messages 28 as was earlier described with regard to the scrollable HTML compatible window.

The method may further comprise the step of displaying at least a portion of all of the informational messages 28 that may be stored in the data processing system 26 such that a user may access certain informational messages 28 as desired. As was earlier mentioned, the informational message 28 may be retrieved from a computer readable storage medium. Such informational message 28 may also be part of a related series of informational messages 28 wherein the method may further comprise the step of responding to a user search request to display at least a portion of any remaining informational messages 28 that had been previously stored in the data processing system 26.

As a means to provide a more focused demographic profile reach for which allocation of informational messages 28 may be allocated to users, the method may further comprise the step of tracking the types of informational messages 28 that have been displayed on a particular user's display device 12 and/or which have been retrieved from a data processing system 26. Such tracking of informational message 28s may be recorded in a log. The method may further comprise transferring contents of the log to a remote location to facilitate providing at least a portion of a log contents to a sponsor of the informational messages 28.

In this manner, vital contact details may be easily captured by sponsors such that informational messages 28 can be provided with more relevancy to the users. The method may further comprise the step of updating the informational messages 28 that are stored in the data processing system 26 based upon user search preferences that are stored at a remote location. In this manner, targeting of relevant types of informational messages 28 may be allocated or distributed to the appropriate users.

Upon receiving a desire informational message 28 upon which the user desires to act, the method may further comprise the steps of providing user input in response to the informational message 28. In the above example, a user desiring delivery of a certain food item such as pizza may enter the word “pizza” in the VOIP dialer 18 search field 22 whereupon the VOIP dialer 18 may be connected to a host device 34 to allow for communication therebetween. Practically, the user may connect with the host device 34 via the VOIP dialer 18, a modem, and any other necessary hardware. The user's location may be ascertained such as through information obtained by the user's internet service provider (ISP). Such sponsor may be a local business that may have VOIP capability. If so, a VOIP connection may be provided between the user and the sponsor or the sponsor's affiliate. Such communication may be voice and/or data. If a voice connection is established, the user may then request certain services and/or goods from the sponsor after which the sponsor may provide such services to the address of the user.

The present invention further provides a method of displaying the informational message 28 on the display device 12 based upon a user search request and at least one user identifier. The informational message 28 may be retrieved from among a plurality of informational messages 28 that may be stored on a local data processing system 26. The method may comprise the steps of connecting local data processing system 26 to a remote data processing system 26. The informational message 28 may be then selected from among the plurality such that the informational message 28 retrieved from the remote data processing system 26 which is based upon the geographical location of the local data processing system 26.

The informational message 28 may be stored on the local data processing system 26. The method further comprises the steps of receiving the user identifier that identifies a particular user of the local data processing system 26. The dialog box 20 is then displayed on the display device 12 to allow the display of the status of the user search request on the dialog box 20. The method then comprises the step of selecting the informational message 28 from among the plurality stored on the local data processing system 26 based upon both the user search request and the user identifier. The informational messages 28 then displayed and the user search request is displayed conterminously therewith.

The above methodologies may be performed using a computer readable storage medium which contains computer programming instructions for rendering and/or displaying informational message 28 on the data processing system 26. The computer programming instructions may comprise receiving at least one informational message 28 from the computer readable storage medium with the informational message 28 being selected from the user search request which has a geographical location of the data processing system 26 after which a user search request is received which allows for initiation of an application task.

The programming instructions then comprise executing the application task and rendering the status of the user search request. Such rendering may include displaying or audibly signaling the status of the user search request for the user's benefit. The programming instructions may comprise rendering the informational message 28 conterminously with the user search request status during periods of non-communication between the data processing system 26 and the user. For example, such periods of inactivity or non-communication may occur when the user inputs additional information into the computer readable storage medium.

Alternatively, the period of inactivity or non-communication between a data processing system 26 and the user may occur during completion of the requested application task. As was mentioned above, the informational message 28 may include at least one of the current time of the day and/or the current date as correlated to the data processing system 26. The programming instruction may further include executing the application task while executing a printing task with a program instruction of rendering the informational message 28 comprising playing an audio message or signal during execution of such printing task. The program instruction of executing the application task may comprise executing an operating system start up task which may be accompanied by the rendering of a message during execution of the operating system start up task.

The above description of the system and method is given by way of example and not limitation. Given the above disclosure, one skilled in the art could devise variations that are within the scope of the invention disclosed herein. Furthermore, the various features of the embodiments and methodologies disclosed herein can be used alone or in various combinations with each other and are therefore not intended to be limited to the specific combination described herein. Thus, the scope of the claims is not to be limited by the illustrated embodiments or methodologies described.

What is claimed:

1. A method for retrieving at least one informational message from a computer readable storage medium of a data processing system using a VOIP dialer having a dialog box displayed on a display device in communication with the data processing system, the method comprising the steps of:
a. entering a user search request into the dialog box;
b. retrieving the informational message from the data processing system based upon predefined user search preferences;
c. resizing the dialog box on the display device such that at least part of the user search request status is visible; and
d. displaying the informational message on the dialog box conterminously with the display of the user search request status.

2. The method of claim 1 wherein the informational message is configured as an advertisement for at least one of goods and services.

3. The method of claim 1 wherein the step of displaying the dialog box includes automatically resizing the dialog box to occupy an area of the display device.

4. The method of claim 1 wherein the VOIP dialer is operative to display informational messages in the form of at least one of text, graphics, sound, animation and video.

5. The method of claim 1 wherein the user search preferences include at least one of food types, automotive information, business names, career information, entertainment information, games, music information, news, sports information, hobby information, community service information, data processing system status.

6. The method of claim 1 wherein the dialog box is configured as a scrollable HTML-compatible window and the informational message is displayed therewithin and includes at least one hypertext link.

7. The method of claim 1 wherein the step of displaying the informational message includes displaying a print function enabling printing of an image on a printing device.

8. The method of claim 1 wherein the step of displaying the informational message includes displaying at least one of a current time of day and current date [stored within the data processing system].

9. The method of claim 1 wherein the step of displaying the informational message includes displaying at least a portion of all of the informational messages stored in the data processing system.

10. The method of claim 1 further comprising the steps of:
e. recording a log of the informational messages displayed on the dialog box;
f. transferring the log to a remote location; and
g. providing at least a portion of the log contexts to a sponsor of at least one of the informational messages.

11. The method of claim 1 wherein the step of displaying the informational message includes updating the informational messages stored in the data processing system based upon the user search preferences stored at the remote location.

12. The method of claim 1 further comprising the steps of:
h. receiving user input in response to the informational message; and
i. connecting the VOIP dialer to a host device for communication therebetween.

13. A method for displaying at least one informational message on a display device, the informational message being based upon a user search request and at least one user identifier, the informational message being retrieved from among a plurality thereof stored on a local data processing system, the method comprising the steps of:
a. connecting the local data processing system to a remote data processing system;
b. selecting the informational message to be retrieved from the remote data processing system based upon a geographical location of the local data processing system.
c. storing the informational message on the local data processing system;
d. receiving the user identifier configured to identify a user of the local data processing system;
e. displaying a dialog box on the display device;
f. displaying a status of the user search request on the dialog box;
g. selecting the informational message from among the plurality of the informational messages stored on the local data processing system based upon the user search request and the user identifier; and
h. displaying the informational message and the user search request conterminously on the dialog box.

14. A telecommunications system for searching for at least one informational message on a data processing system, the telecommunications system comprising:
a computer readable storage medium of the data processing system;
a display device in communication with the data processing system; and
a VOIP dialer having a dialog box displayable on the display device, the VOIP dialer being operative to receive a user search request in the dialog box, retrieve the informational message from the computer readable storage medium, display the informational message on the dialog box conterminously with the user search request status.

15. The telecommunications system of claim 14 further comprising:
an advertisement distribution scheduler in communication with the data processing system;
wherein the informational message is configured as an advertisement, the advertisement distribution scheduler being operative to assign a demographic profile reach to each advertisement for allocation thereof to a list of users.

16. The telecommunications system of claim 14 wherein the advertisement distribution scheduler is operative to store at least one of frequency, duration, and expiration time of the advertisement.

17. The telecommunications system of claim 14 wherein the informational message is retrieved from the data processing system based upon predefined user search preferences.

18. The telecommunications system of claim 17 wherein the user search preferences include at least one of food types, automotive information, business names, career information, entertainment information, games, music information, news, sports information, hobby information, community service information, data processing system status.

19. The telecommunications system of claim 14 wherein the informational message is configured as an advertisement for at least one of goods and services.

20. The telecommunications system of claim 14 wherein the VOIP dialer is operative to display informational messages in the form of at least one of text, graphics, sound, animation and video.
